(19) United States
(12) Patent Application Publication
(10) Pub. No.: US 2006/0272684 A1
(43) Pub. Date: Dec. 7, 2006

(54) Method of and apparatus for cleaning fouling in heat exchangers, waste-heat boilers and combustion chamgers

(76) Inventor: Frans Steur JR., Helvesiek (DE)

Correspondence Address: NEIL A. STEINBERG, 2665 MARINE WAY, SUITE 1150, MOUNTAIN VIEW, CA, 94043, US

(21) Appl. No.: 11/142,565

(22) Filed: Jun. 1, 2005

(51) Int. Cl. B08B 3/00

(52) U.S. Cl. 134/166 C; 134/56 R; 134/105

(57) ABSTRACT

It is generally known that heat exchangers, waste-heat boilers and combustion chambers, that is to say spaces in which combustion takes place and which are provided with corresponding lines through which flows a medium to be heated, have to be cleaned at certain time intervals. The reason for that cleaning operation is that the lines through which the medium to be heated flows soot up at their outside due to the combustion process within the combustion chamber or are covered by a layer of combustion residues which impede or prevent the transfer of heat, which ultimately reduces the level of efficiency of the installation. It is here that the invention is involved, the object thereof being to avoid the previous disadvantages and in addition also to permit a cleaning process if the temperature within the space to be cleaned has not yet fallen to room temperature or a temperature below 100° C. A device for cleaning contamination in heat exchangers, waste-heat boilers or combustion chambers, characterised in that the device comprises a tube which is of a great length with at the same time relatively small diameter, wherein a combustible gas mixture and/or a blasting body is provided within the tube and the tube is destroyed after blasting and that the tube comprises a first tube and a second tube hingedly connected thereto and arranged within the second tube is a fuse which is connected to a blasting cord.

It is generally known that heat exchangers, waste-heat boilers and combustion chambers, that is to say spaces in which combustion takes place and which are provided with corresponding lines through which flows a medium to be heated, have to be cleaned at certain time intervals. The reason for that cleaning operation is that the lines through which the medium to be heated flows soot up at their outside due to the combustion process within the combustion chamber or are covered by a layer of combustion residues which impede or prevent the transfer of heat, which ultimately reduces the level of efficiency of the installation.

It is also already known that so-called explosion cleaning procedures are implemented for cleaning such spaces and lines. For that purpose for example a textile bag is filled with a gas mixture outside the space to be cleaned and introduced into the space which is to be cleaned and there caused to explode. Such a method involves a cleaning operation in ball form as the entire explosive effect emanates from the textile bag which ideally can be assumed to be in the form of a ball. The problem in this respect is that contamination which is applied externally to the lines or inside walls of the space and which can be reached directly by the explosion effect can admittedly possibly be eliminated. As however the lines which carry the medium to be heated are often very close together, the blasting effect can detach only a small part of the pollutants and contaminating material but frequently not contaminating material and pollutants which are disposed between the tubes or, as viewed from the explosion point, behind the tubes.

It is here that the invention is involved, the object thereof being to avoid the previous disadvantages and in addition also to permit a cleaning process if the temperature within the space to be cleaned has not yet fallen to room temperature or a temperature below 100° C.

That object is attained by a method having the features set forth in claim 1 and an apparatus having the features set forth in claim 3. Advantageous developments are described in the appendant claims.

The invention does not provide for effecting blasting in a ball shape within the combustion chamber, but linear blasting, that is to say a blasting process in which the blasting effect is distributed over a great length. For that purpose a tube, for example a tube of cardboard and/or copper, is filled with a gas mixture and/or provided on the inside with a blasting cord so that the desired blasting effect can be achieved by the blasting process. The explosion in accordance with the invention generates a shock wave which, upon impinging on polluting contamination which is to be cleaned off, blasts it away. The small tube diameter means that cleaning between the contaminated lines or bundles of lines is also possible and, if a coolant is flowing through the blasting tube, the cleaning operation can also take place during operation or after operation has been shut down for a short time if the temperature within the combustion chamber (of the heat exchanger) has not yet fallen very far. That means that no relevant downtimes, as are hitherto usual of up to several days, are caused for the cleaning operation itself.

The invention is described hereinafter by means of examples:

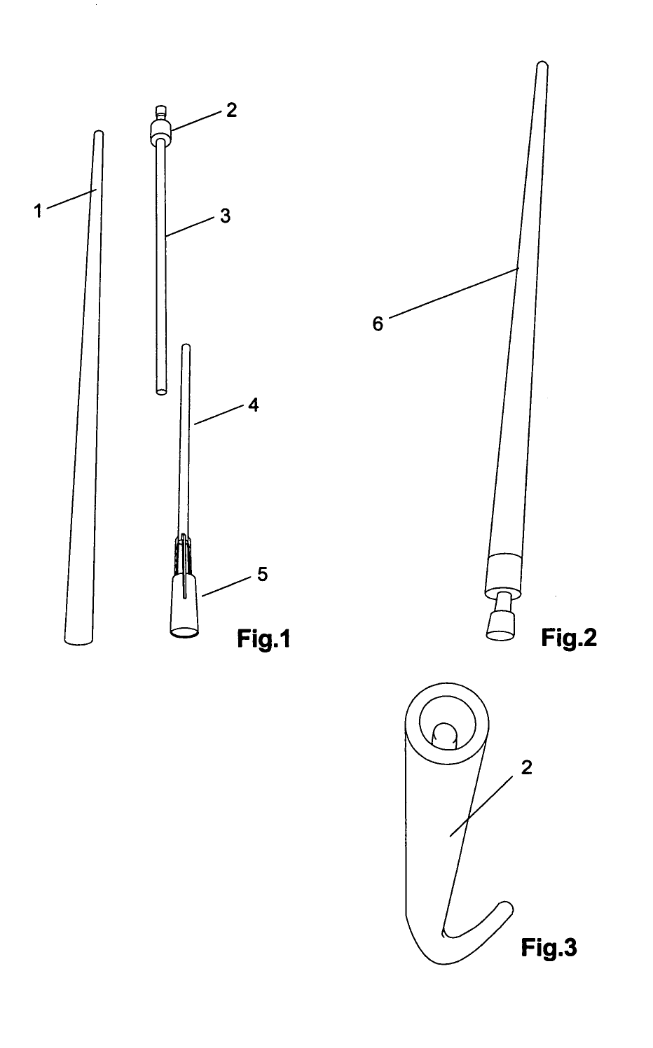

FIG. 1 shows a cardboard tube 1 which accommodates a spark plug 2. The tube is provided at one end with a closure means and a gas filling connection is provided at the other end.

FIG. 2 shows the overall device in the assembled condition.

Depending on the respective use involved, the tube can be made of any desired length and, as can be seen in the illustrated example, the tube is of a relatively small diameter of for example 3 cm to 15 cm so that it can also be introduced into the gases of the heat exchanger line within the combustion chamber.

After triggering of the blasting action by which the entire cardboard tube is broken up, the parts such as the filling head—triggering spark plug, screwthreaded rod, closure means and so forth can be further used again.

FIG. 3 shows an alternative embodiment. It can be seen in this respect that fitted into the combustion chamber is a first tube which is connected by way of a hinge to a second tube. Due to the hinge, the respective angle of the second tube (blasting tube) can be so adjusted as is precisely desired.

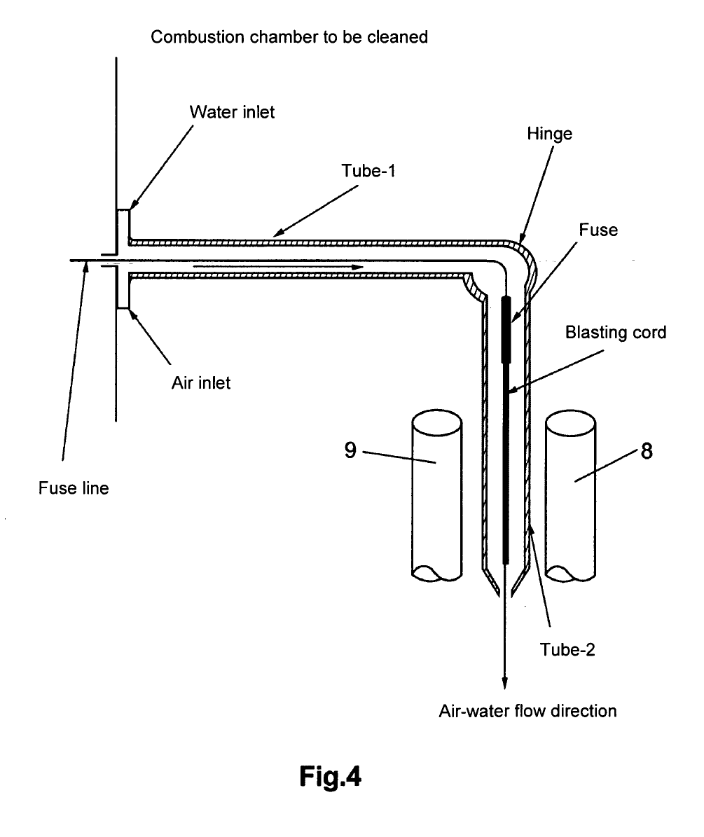

FIG. 4 shows in the illustrated example a view of an embodiment of the invention by way of example. In this case a first tube 1 is connected by way of a hinge to a second tube 2. Arranged within the second tube is a fuse which is connected to a blasting cord.

If now the described arrangement is introduced into a combustion chamber, more specifically between tube bundles 8 and 9 therein, then cleaning of the tubes can be effected by means of triggering the blasting, that is to say by means of the explosion, and, so that the blasting does not take place at an unwanted moment in time, the tube interior is suitably cooled by means of a supply of water (or a supply of air) which flows in by way of the first tube 1, so that it is reliably possible to prevent unwanted triggering of the explosion.

Provided within the second tube 2 is a blasting cord (and possibly an explosive gas mixture) and the blasting cord is connected to a fuse. As further shown in FIG. 4 the first tube, like also the second tube, has a coolant flowing therethrough, being an air/water mixture in the illustrated example. The fuse is connected by way of a fuse line to the triggering device of the firing mechanism outside the tube. The coolant flows into the first tube and by way of the hinge also into the second tube so that the fuse and the blasting cord are sufficiently cooled so that an unforeseen explosion is not prematurely triggered.

When the blasting process is triggered, the outer tube, for example if it is made from cardboard, glass, metal, copper or plastic material, is shattered (as in the case of a hand grenade) and the individual particles which are blasted off impinge on the contaminating material on the tubes to be cleaned, within the combustion chamber. In that situation the contaminating material is detached.

If the fuse is provided with a temperature sensor then the amount of coolant can be so adjusted that unforeseen blasting is not prematurely caused.

As can also be seen in the illustrated examples, the blasting tubes are of such dimensions that they also fit between the lines to be cleaned within the combustion chamber and thus contaminating material which, as viewed from the combustion chamber, is between or behind the lines, can also be detached therefrom.

What is claimed is:

1. A device for cleaning contamination in heat exchangers, waste-heat boilers or combustion chambers, characterised in that
the device comprises a tube which is of a great length with at the same time relatively small diameter, wherein a combustible gas mixture and/or a blasting body is provided within the tube and the tube is destroyed after blasting and that the tube comprises a first tube and a second tube hingedly connected thereto and arranged within the second tube is a fuse which is connected to a blasting cord.

2. A method according to claim 1 characterised in that blasting is effected during operation of the assembly to be cleaned or is effected after the assembly to be cleaned has been shut down if the temperature in the interior of the assembly is still above 300° C., preferably above 700° C.

3. A device for cleaning contamination in heat exchangers, waste-heat boilers or combustion chambers, characterised in that the device comprises a tube which is of a great length with at the same time relatively small diameter, wherein a combustible gas mixture and/or a blasting body is provided within the tube and the tube is destroyed after blasting.

4. A device according to claim 3 characterised in that the tube comprises a first tube and a second tube hingedly connected thereto, wherein arranged within the second tube is a fuse which initiates blasting upon triggering and the second tube is so oriented that the greatest blasting effect is achieved and the fuse is connected by way of a fuse line to a fuse triggering mechanism.

5. A device according to one of the preceding claims characterised in that provided within the tube is a passage which encloses the blasting cord and/or the explosion gas and the passage accommodates a coolant.

6. A device according to claim 5 characterised in that the coolant is an air/water mixture.

7. A device according to one of the preceding claims characterised in that a temperature sensor is provided at the fuse and the amount of the coolant is adjusted by automated control in dependence on the temperature measured at the fuse, such that unforeseen blasting does not occur.

8. A device according to one of the preceding claims characterised in that a plurality of tubes are combined to form a tube bundle.
